(19) United States
(12) Patent Application Publication
(10) Pub. No.: US 2013/0252614 A1
(43) Pub. Date: Sep. 26, 2013

(54) METHODS FOR PREFERABLY CAMPING ON AND STAYING IN A CELL BELONGING TO A HIGH DATA TRANSMISSION THROUGHPUT RAT AND COMMUNICATIONS APPARATUSES UTILIZING THE SAME

(71) Applicants: Ming-Wan HSU, Taipei City (TW); Chung-Yun CHANG, Taichung City (TW); Chang-Hua YANG, Yuanlin Township (TW); Chih-Chung LIN, New Taipei City (TW); Chien-Nan CHOU, Tainan City (TW); Chih-Yung SHIH, Hsinchu City (TW)

(72) Inventors: Ming-Wan HSU, Taipei City (TW); Chung-Yun CHANG, Taichung City (TW); Chang-Hua YANG, Yuanlin Township (TW); Chih-Chung LIN, New Taipei City (TW); Chien-Nan CHOU, Tainan City (TW); Chih-Yung SHIH, Hsinchu City (TW)

(73) Assignee: MEDIATEK INC., Hsin-Chu (TW)

(21) Appl. No.: 13/604,375

(22) Filed: Sep. 5, 2012

Related U.S. Application Data
(60) Provisional application No. 61/615,050, filed on Mar. 23, 2012.

(51) Int. Cl. H04W 36/14

(52) U.S. Cl. 455/437

(57) ABSTRACT

A communications apparatus includes a processor coupled to at least one RF transceiver and at least one baseband processing device and capable of communicating with a first wireless network belonging to a first RAT and a second wireless network belonging to a second RAT having a higher data transmission throughput than the first RAT. A first processor logic unit of the processor performs an enhanced cell search procedure via the RF transceiver to find one or more cell(s) belonging to the second RAT having stronger signal strength and/or better signal quality than a predetermined threshold, which are not included in a broadcast neighbor cell list. A second processor logic unit of the processor determines a suitable cell from among the cell(s) and performs a cell reselection procedure to camp on the suitable cell.

### CROSS REFERENCE TO RELATED APPLICATIONS

This application claims the benefit of U.S. Provisional Application No. 61/615,050 filed Mar. 23, 2012 and entitled “Methods for preferably staying cells with high-throughput radio access technology”. The entire contents of which are hereby incorporated by reference.

### BACKGROUND OF THE INVENTION

1. Field of the Invention

The invention relates to a method for a communications apparatus to preferably camp on and stay in a cell belonging to a high data transmission throughput radio access technology (RAT).

2. Description of the Related Art

The term “wireless”, normally refers to an electrical or electronic operation that is accomplished without the use of a “hard wired” connection. “Wireless communications”, is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to other parties from many locations world-wide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly adopted communications system, which uses time division multiple access (TDMA) technology, which is a multiplex access scheme for digital radio to send voice, data, and signalling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. Wireless Fidelity (Wi-Fi) is a technology defined by the 802.11 engineering standard that can be used for home networks, mobile phones, video games, and to provide a high-frequency wireless local area network.

### BRIEF SUMMARY OF THE INVENTION

Communications apparatuses and methods for a communications apparatus to preferably camp on and stay in a cell belonging to a high data transmission throughput RAT are provided. An exemplary embodiment of a communications apparatus capable of communicating with a first wireless network belonging to a first radio access technology (RAT) and a second wireless network belonging to a second RAT having a higher data transmission throughput than the first RAT and currently camping on a cell belonging to the first RAT or the second RAT comprises a processor coupled to at least one radio frequency (RF) transceiver for receiving or transmitting RF signals from or to the first wireless network and the second wireless network, and at least one baseband processing device for processing baseband signals received from or transmitted to the first wireless network and the second wireless network. The processor at least comprises a first processor logic unit performing an enhanced cell search procedure via the RF transceiver to find one or more cell(s) belonging to the second RAT and having stronger signal strength and/or better signal quality than a predetermined threshold, which are not included in a broadcast neighbor cell list, and a second processor logic unit, determining a suitable cell from among one or more cell(s) and performing a cell reselection procedure to camp on the suitable cell.

An exemplary embodiment of a method for a communications apparatus to preferably camp on and stay in a cell belonging to a high data transmission throughput radio access technology (RAT), wherein the communications apparatus is capable of communicating with a first wireless network belonging to a first RAT and a second wireless network belonging to a second RAT having a higher data transmission throughput than the first RAT and currently camps on a cell belonging to the first RAT or the second RAT. The method comprises: performing an enhanced cell search procedure via a RF transceiver of the communications apparatus by a processor of the communications apparatus to find one or more cell(s) belonging to the second RAT and having stronger signal strength and/or better signal quality than a predetermined threshold, which are not included in a broadcast neighbor cell list; determining a suitable cell from among one or more cell(s) by the processor; and performing a cell reselection procedure to camp on the suitable cell by the processor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a communications apparatus according to an embodiment of the invention;

FIG. 2 shows a block diagram of a communications apparatus according to another embodiment of the invention;

FIG. 3 is a flow chart of a method for a communications apparatus to preferably camp on and stay in a cell belonging to a high data transmission throughput RAT according to an embodiment of the invention;

FIG. 4 is a flowchart illustrating an embodiment of a method for preferably staying in 3G cells when the communications apparatus is currently camped on a 3G cell according to an embodiment of the invention;

FIG. 5 is a flowchart illustrating an embodiment of a method for preferably staying in 3G cells when the communications apparatus is currently camped on a 2G cell according to an embodiment of the invention;

FIG. 6 is a flowchart illustrating an embodiment of a method for preferably staying in 3G cells when the communications apparatus is currently camped on a 3G cell according to another embodiment of the invention;

FIG. 7 is a flowchart illustrating an embodiment of a method for preferably staying in 3G cells when the communications apparatus is currently camped on a 2G cell according to another embodiment of the invention;

FIG. 8 is a flowchart illustrating an embodiment of a method for preferably staying in 3G cells when the communications apparatus is currently camped on a 3G cell according to yet another embodiment of the invention; and

FIG. 9 is a flowchart illustrating an embodiment of a method for preferably staying in 3G cells when the communications apparatus is currently camped on a 2G cell according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

With advancements in communications techniques, mobile stations (MS, which may be interchangeably referred to as user equipment (UE)) are now capable of handling different radio access technologies (RAT), such as at least two from among GSM/GPRS/EDGE (Global System for Mobile Communications/General Packet Radio Service/Enhanced Data rates for Global Evolution), WCDMA (Wideband Code Division Multiple Access), cdma2000, WiMAX (Worldwide Interoperability for Microwave Access), TD-SCDMA (Time Division Synchronous Code Division Multiple Access), LTE (Long Term Evolution), and TD-LTE (Time Division Long Term Evolution) RATs or the like, via one communications apparatus.

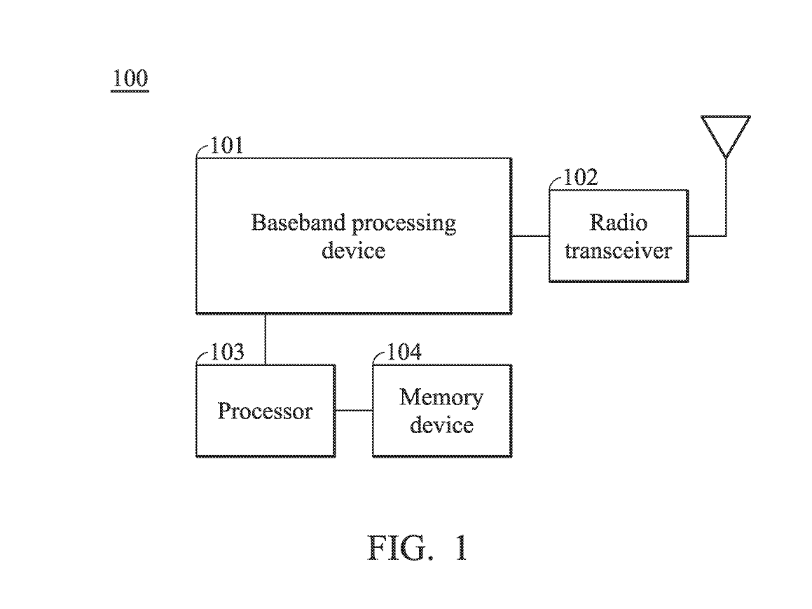

FIG. 1 shows a block diagram of a communications apparatus according to an embodiment of the invention. The communications apparatus 100 may comprise a baseband processing device 101, a radio transceiver 102, a processor 103 and a memory device 104. The radio transceiver 102 may receive wireless radio frequency signals, convert the received signals to baseband signals to be processed by the baseband processing device 101, or receive baseband signals from the baseband processing device 101 and convert the received signals to wireless radio frequency signals to be transmitted to a peer device. The radio transceiver 102 may comprise a plurality of hardware devices to perform radio frequency conversion. For example, the radio transceiver 102 may comprise a mixer to multiply the baseband signals with a carrier oscillated in the radio frequency of the wireless communications system, wherein the radio frequency may be, for example, 900 MHz or 1800 MHz for a global system for mobile communication (GSM), or 1900 MHz for a Universal Mobile Telecommunications System (UMTS), or others.

The baseband processing device 101 may further convert the baseband signals to a plurality of digital signals, and process the digital signals, and vice versa. The baseband processing device 101 may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on. The memory device 104 may store the system data and program codes of the communications apparatus 100. The processor 103, when loading and executing the program codes with the system data, may control the operations of the baseband processing device 101, the radio transceiver 102, and the memory device 104.

According to an embodiment of the invention, the communications apparatus 100 may provide the capability to communicate with multiple wireless networks that are belonging to different RATs, such as the Global System for Mobile Communications/General Packet Radio Service/Enhanced Data Rate for GSM Evolution (GSM/GPRS/EDGE, also called 2.xG) network and the Universal Mobile Telecommunications System (UMTS, also called 3G) network. The processor 103 may be a micro-processing unit (MCU) embedded in the baseband processing device 101 or may be configured outside of the baseband processing device 101 as shown in FIG. 1, and may interact with the radio transceiver 102 to transit data via the air interface.

According to an embodiment of the invention, the processor 103 may be arranged to execute the program codes of the corresponding software module(s) of the baseband processing device 101 and/or the radio transceiver 102. The program codes accompanied with specific data in a data structure may also be referred to as a processor logic unit or a protocol stack instance, when being executed. Therefore, the processor 103 may be regarded as comprising a plurality of processor logic units each for executing one or more specific functions or tasks of the corresponding software module(s).

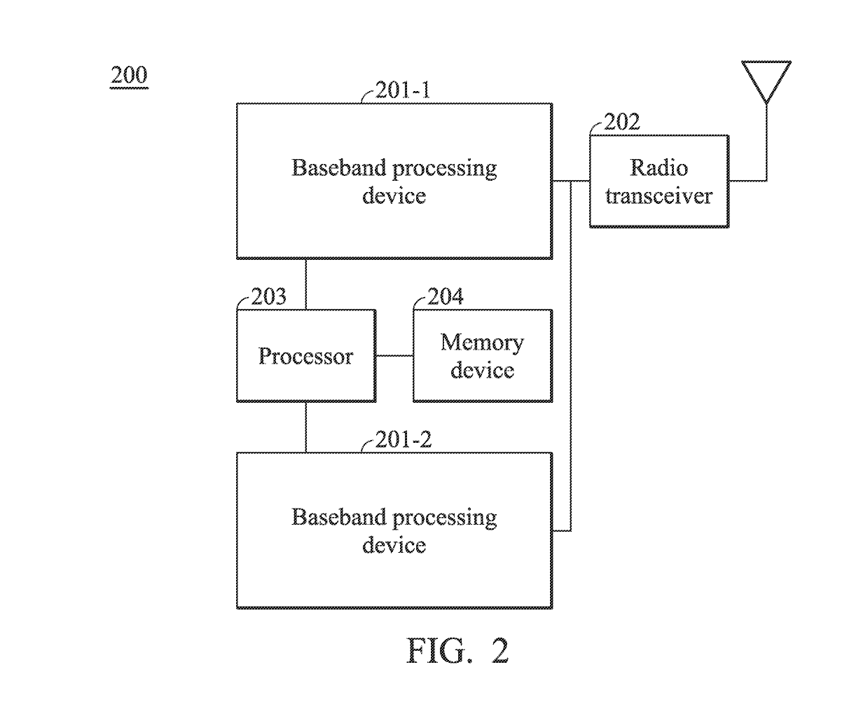

FIG. 2 shows a block diagram of a communications apparatus according to another embodiment of the invention. The communications apparatus 200 may comprise baseband processing devices 201-1 and 201-2, a radio transceiver 202, a processor 203 and a memory device 204. The baseband processing devices 201-1 may be configured for performing baseband signal processing for a first RAT and the baseband processing devices 201-2 may be configured for performing baseband signal processing for a second RAT different from or the same as the first RAT. Because the communications apparatus 200 has a similar structure to the communications apparatus 100, for descriptions concerning the baseband processing devices 201-1 and 201-2, the radio transceiver 202, the processor 203 and the memory device 204, reference may be made to the introductions of the communications apparatus 100 shown in FIG. 1 as illustrated above, and are omitted here for brevity.

Note that, in some embodiments of the invention, the processor 203 may be embedded in one of the baseband processing devices 201-1 and 201-2. In addition, in some other embodiments of the invention, there may be two processors configured in one communications apparatus, and each may be arranged to execute the program codes of the corresponding software module(s) of one of the baseband processing devices and/or the radio transceiver. In addition, in still some other embodiments of the invention, there may be two radio transceivers configured in one communications apparatus wherein each is arranged to perform the transceiving task of a corresponding RAT. Therefore, the invention should not be limited to the embodiment as shown in FIG. 2.

Note that although the invention has been described by way of a communications apparatus capable of communicating with two wireless networks belonging to two RATs, it is to be understood that the concept can also be modified and extended to a communications apparatus capable of communicating with more than two wireless networks belonging to more than two RATs. Therefore, the scope of the appended claims should be accorded the broadest interpretation so as to encompass all such modifications and similar arrangements. To simplify the descriptions, 2G and 3G networks are taken as the exemplary RATs in the following embodiments to clarify the spirit of the invention. However, without departing from the spirit of the invention, those skilled in the art may practice the following inventive methods to any communications apparatus capable of supporting more than two radio access technologies (RATs), or any communications apparatus capable of supporting any other more advanced RAT, for example, a 2G/4G or a 2G/3G/4G, or others.

According to an embodiment of the invention, after powering on, the communications apparatus (e.g. the communications apparatus 100 or 200) looks for a suitable cell of a registered public land mobile network (PLMN) and chooses that cell to provide available services, and tunes to its control channel. This choosing is known as a “cell selection” or “camping on the cell”. When the communications apparatus (e.g. the communications apparatus 100 or 200) firstly camps on the serving cell, the system information indicating the neighbor cells, both 2G and 3G cells, will be transmitted to the communications apparatus (e.g. the communications apparatus 100 or 200) via a broadcast channel. Moreover, the system information may further contain a measurement rule for cell reselection and a report request for radio link establishment.

In the case of a UMTS network, although the same wideband frequency is used by adjacent cells, the neighboring cells listed in the broadcast system information are physically identified by their different primary scrambling codes (PSC), and the communications apparatus (e.g. the communications apparatus 100 or 200) may constantly monitor the Common Pilot Channel (CPICH) to measure the signal power levels of the neighboring cells so as to obtain the signal strength and/or signal quality thereof (for example, Energy over Noise Ratio (Ec/No), Received Signal Code Power (RSCP), and so on). The power measurement information may then be used to evaluate whether the UMTS/WCDMA cell should be added to the candidate cell list for possible cell reselection.

It is well-known by those skilled in the art that 3G theoretically has higher data throughput than 2G However, in some cases, the power measurement results obtained from an inter-RAT cell measurement and an intra-RAT cell measurement may indicate that there is no qualified 3G cell in the broadcast neighboring cell list that can be added to the candidate cell list, but at least one qualified 2G cell being ranked better than the serving cell (for example, a 3G cell). Thus, an inter-RAT cell reselection may possibly be performed to reselect to a 2G cell with the greatest quality, resulting in degraded data throughput.

To address the aforementioned drawback, methods for a communications apparatus to preferably camp on and stay in high data transmission throughput cells will be introduced to enable a periodic, or at least one-time, enhanced cell search procedure to discover one or more potential neighboring cells that belong to a high data transmission throughput RAT (for example, 3G) and may not be broadcast in the system information or may not be added to the neighbor cell list by the wireless network. When observing that the signal power, strength, and/or quality of the serving cell drops to a scenario, or the serving cell might no longer be used, the processor (e.g. the processor 103 or 203) of the communications apparatus may trigger a cell reselection procedure based on the results obtained in the enhanced cell search procedure, so as to reselect to the newly discovered cell (for example, a 3G cell) having high data transmission throughput and avoid camping on a low data transmission throughput cell (for example, a 2G cell).

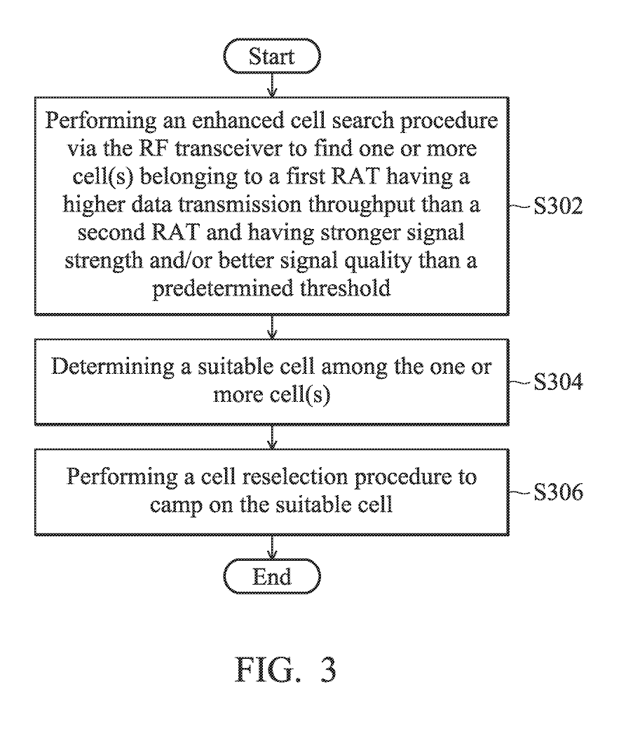

FIG. 3 is a flow chart of a method for a communications apparatus to preferably camp on and stay in a cell belonging to a high data transmission throughput RAT according to an embodiment of the invention. The processor (e.g. the processor 103 or 203) may first perform an enhanced cell search procedure via the RF transceiver to find one or more cell(s) belonging to a first RAT having a higher data transmission throughput than a second RAT, and having stronger signal strength and/or better signal quality than a predetermined threshold (Step S302), where the first RAT and second RAT are both supported by the communications apparatus. Next, the processor (e.g. the processor 103 or 203) may determine a suitable cell from among one or more cell(s) (Step S304). Finally, the processor (e.g. the processor 103 or 203) may perform a cell reselection procedure to camp on the suitable cell (Step S306). Note that, as previously described, steps S302, S304 and S306 may be performed by one or more processor logic units of the processor.

According to an embodiment of the invention, the enhanced cell search procedure may be done by performing a frequency scan on one or more predetermined frequency band(s). Generally, a public land mobile network (PLMN) may provide service in one, or a combination of, multiple frequency bands. Therefore, in the embodiments of the invention, the predetermined frequency band(s) may be the frequency band(s) in which a PLMN provides the wireless communications services. Information regarding the predetermined frequency band(s) may be obtained from a registered PLMN (RPLMN) frequency list, where the RPLMN refers to the PLMN that the communications apparatus has registered with. The communications apparatus may build up and maintain the RPLMN frequency list according to the UARFCN (ultra absolute radio frequency channel number) corresponding to the RPLMN carried in the system information, or according to the stored records of the frequency bands corresponding to the RPLMN obtained when the network was visited previously.

For example, when an RPLMN provides 3G wireless communications services in UARFCN 10737 and 10688, the processor may perform the enhanced cell search procedure by performing a frequency scan on the frequency bands of 10737 and 10688 so as to find all of the possible 3G cells (regardless of whether the 3G cell exists in the neighbor cell list broadcast by the wireless network of a currently camped-on cell or not) having a stronger signal strength and/or better signal quality than the predetermined threshold. One merit of scanning all frequency band(s) of an RPLMN instead of only measuring the neighboring cells carried in the neighbor cell list is that, in cases when a qualified cell is not added to the neighbor cell list, the qualified cell may probably be discovered after performing the enhanced cell search procedure.

According to an embodiment of the invention, the predetermined threshold may be one or a combination of the signal strength and signal quality of the currently camped-on cell. According to another embodiment of the invention, the predetermined threshold may also be one or a combination of criteria specified in the corresponding standards, such the S-criteria. According to yet another embodiment of the invention, the predetermined threshold may also be flexibly defined according to previous experience obtained from lab experiments or field trial results. In addition, according to an embodiment of the invention, the enhanced cell search procedure may be preformed periodically or aperiodically.

Taking the RATs 2G and 3G as an example, when the currently camped-on cell is a 3G cell, the enhanced cell search procedure may be performed when the signal strength and/or signal quality of the currently camped-on 3G cell has/have been downgraded. According to an embodiment of the invention, the timing of triggering the enhanced cell search procedure may be set before reselecting to a 2G cell. For example, when a 2G cell having a signal strength and/or signal quality that is stronger and/or better than that of the currently camped-on 3G cell is found after performing an inter-RAT measurement, the enhanced cell search procedure may be triggered. Conventionally, a cell reselection procedure may be subsequently performed after finding the 2G cell so as to reselect to the 2G cell and start to listen to the system information of the 2G cell, leading to a downgraded data transmission throughput. However, in the embodiment of the invention, because the enhanced cell search procedure is triggered, once a 3G cell having a signal strength and/or signal quality that is stronger and/or better than the predetermined threshold has been found, the communications apparatus (e.g. the communications apparatus 100 or 200) may find out a suitable 3G cell, which is not included in the broadcast neighbor cell list, and preferably reselect to the 3G cell rather than the 2G cell. Therefore, the data transmission throughput will not be downgraded to the level supported by the 2G RAT.

According to another embodiment of the invention, the timing of triggering the enhanced cell search procedure may be set when the signal strength and/or signal quality of the currently camped-on 3G cell does not satisfy a predefined criterion. According to an embodiment of the invention, the predefined criterion may be defined according to the parameters carried in the system information or the receiving capability of the communications apparatus (e.g. the communications apparatus 100 or 200). According to another embodiment of the invention, the predefined criterion may also be one or a combination of criteria specified in the corresponding standards, such as the S-criteria. For example, the enhanced cell search procedure may be triggered before performing a measurement procedure to measure the power of the 2G cells, such as the above-mentioned inter-RAT measurement.

According to another embodiment of the invention, the designer may implement a design wherein the communications apparatus (e.g. the communications apparatus 100 or 200) is forbidden from reselecting to a 2G cell when the signal strength and/or signal quality of the currently camped-on 3G cell still satisfies the predefined criterion. For example, even when a 2G cell having a signal strength and/or signal quality that is stronger and/or better than the currently camped-on 3G cell has been found, the 2G cell is still not selected as long as the signal strength and/or signal quality of the currently camped-on 3G cell still satisfies the predefined criterion. Once the predefined criterion is no longer satisfied, the enhanced cell search procedure may be triggered and a priority of performing the enhanced cell search procedure may be set higher than a priority of performing the inter-RAT measurement so that one or more 3G cells having stronger signal strength and/or better signal quality than the predetermined threshold may be found earlier than 2G cells.

On the other hand, when the currently camped-on cell is a 2G cell, the enhanced cell search procedure to find one or more 3G cell(s) may be performed periodically, or at least once, regardless of whether the signal strength and/or signal quality of the currently camped-on 2G cell has/have been downgraded. For example, even if the signal strength and/or signal quality of the currently camped-on 2G cell has/have not been downgraded, or even if the condition of triggering an inter-RAT measurement to measure the power of 3G cells has not been satisfied, the enhanced cell search procedure may still be performed and, if feasible, the communications apparatus (e.g. the communications apparatus 100 or 200) reselects to a qualified 3G cell as soon as possible in order to improve the data transmission throughput.

For another example, even if the PSC of one or more 3G cells to be measured is specified in the system information, the enhanced cell search procedure may still be performed so as to scan all of the frequency bands of the RPLMN. Note that, in the embodiments of the invention, the enhanced cell search procedure may be performed prior to a normal cell search procedure, which is designed to find one or more candidate 2G cell(s). Therefore, a 3G cell having a stronger signal strength and/or better signal quality than the predetermined threshold may be found earlier than 2G cells. Note further that, in some embodiments of the invention, the enhanced cell search procedure may be performed to find one or more 3G cell(s) that have stronger signal strength and/or better signal quality than the predetermined threshold, regardless of whether the signal strength and/or the signal quality of the 3G cell(s) is stronger/better than that of the currently camped-on 2G cell.

According to an embodiment of the invention, another predefined criterion may be defined according to the parameters carried in the system information or a receiving capability of the communications apparatus (e.g. the communications apparatus 100 or 200). Once the signal strength and/or signal quality of a 3G cell obtained in the enhanced cell search procedure satisfies the predefined criterion, the communications apparatus may trigger a cell reselection procedure to reselect to the 3G cell. Several exemplary embodiments of periodically or aperiodically performing the enhanced cell search procedure will be described in the following paragraphs.

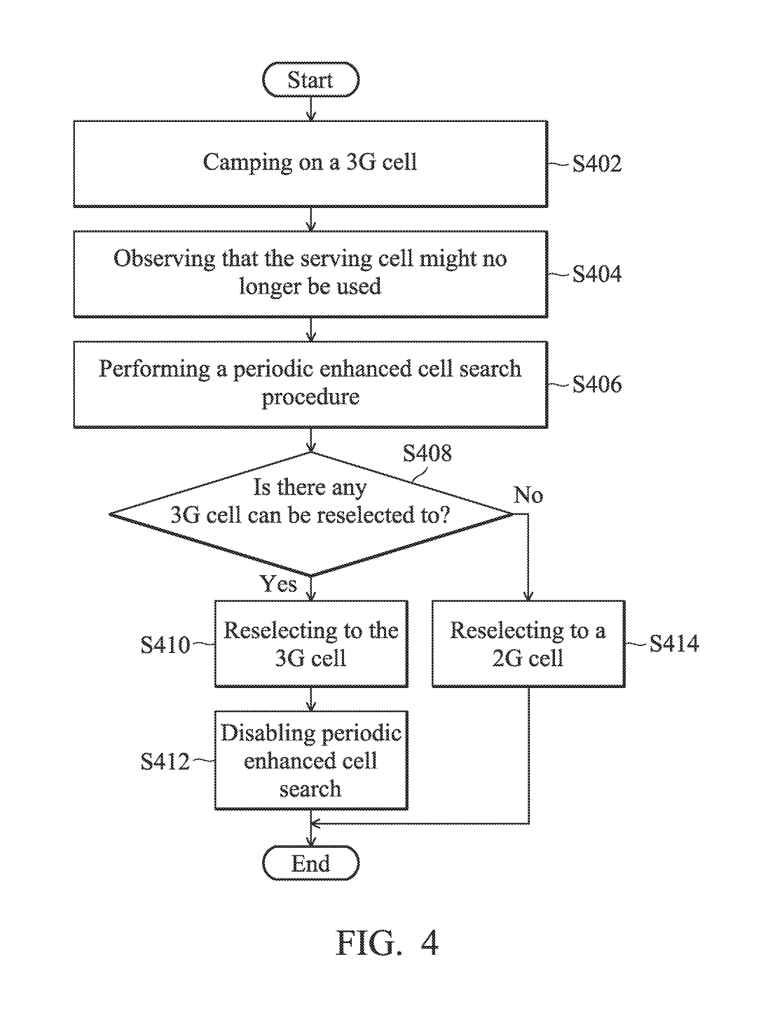

FIG. 4 is a flowchart illustrating an embodiment of a method for preferably staying in 3G cells when the communications apparatus is currently camped on a 3G cell according to an embodiment of the invention. In the embodiment, a 3G cell is camped on as a serving cell in step S402. The communications apparatus may keep monitoring the signal quality and/or signal strength of the serving cell. When observing that the serving cell might no longer be used in Step S404, the processor (for example, the processor 103 or 203) may perform a periodic enhanced cell search procedure in step S406 to find one or more 3G neighboring cells, which are not included in the broadcast neighbor cell list. In terms of the serving cell measurement, the observation in Step S404 may be achieved by determining if the S criteria broadcast via the system information of the serving cell will not be satisfied sooner. Details of the S criteria satisfaction may further refer to the specification 3GPP TS25.304 section 5.2.3.1.2. The processor may alternatively observe if the monitored RSCP and Ec/N0 of the serving cell is lower than a threshold, for example, RSCP<−105 or Ec/NO<−15. The threshold may reflect the communications apparatus's capability, where the Radio Resource Control Connection (RRC Connection) may not be successfully established when the monitored power level of CPICH of the serving cell is lower than the threshold. Or, the processor may observe that the condition of triggering a 2G cell measurement is satisfied, for example, Ec/N0<−n, where n is calculated using parameters carried in the broadcast system information.

When the periodic enhanced cell search procedure is enabled, the processor may control a portion of hardware circuits of the Baseband processing device (for example, the Baseband processing device 101, 201-1 or 201-2) and the RF transceiver (for example, the RF transceiver 102 or 202) to firstly search all known frequencies of registered PLMN for suitable cells. For example, if the current serving cell is UARFCN 10737 and PSC 21, the target frequencies may be contained in the frequency band having the corresponding number 10737. The processor may collect these frequencies of the registered PLMN through system information and previous frequency scan records to discover more neighboring cells, and store the newly discovered neighboring cells for subsequent 3G cell reselection. Each time an enhanced cell search procedure is completed, the processor may configure a timer to start counting and, once the timer expires, trigger the next enhanced cell search procedure. Thus, the enhanced cell search procedure will be performed regularly according to the timer until the periodic enhanced cell search function is disabled.

Specifically, when performing an enhanced cell search procedure, the processor may coordinate with the 3G Baseband processing device and the RF transceiver to perform a power scan operation to locate one or more potential cells with better signal quality in each designated frequency, where the better signal quality may also refer to the signal strength exceeding the predetermined threshold. Following that, the enhanced cell search procedure for each located frequency may contain further steps of slot synchronization, frame synchronization, code-group identification, and scrambling-code identification. For slot synchronization, the communications apparatus may use the primary synchronization code of synchronization Channel (SCH) to achieve slot synchronization with the cell. The slot synchronization may be achieved with a single matched filter (or any similar device) that matches with the primary synchronization code, which is common to all cells. The slot timing of the cell can be obtained by detecting peaks in the matched filter output. During the frame synchronization and code-group identification procedure, the processor may employ the secondary synchronization code of SCH to locate frame synchronization between the communications apparatus and the cell and identify the code group of the cell found in the previous step. The frame synchronization may be achieved by correlating the received signal with all possible secondary synchronization code sequences, and identifying the maximum correlation value. Since the cyclic shifts of the sequences are unique, the code group and the frame synchronization can be determined During the scrambling-code identification procedure, the processor may determine the exact primary scrambling code used by the cell. The primary scrambling code is typically identified through symbol-by-symbol correlation over the common pilot channel (CPICH) with all codes within the code group identified in the previous step. After the primary scrambling code is identified, the primary common control physical channel (CCPCH) may be detected and the cell-specific broadcast channel (BCH) information may be read.

After completing the whole or a portion of the enhanced cell search procedure, the processor may check the search results to determine if there is any 3G cell can be reselected to in step S408. If so, the processor may reselect to the 3G cell in step S410, otherwise, the processor may try to find a suitable 2G cell which ranks better than the serving cell. In the embodiment, the periodic enhanced cell search function may be disabled after reselecting (may also refer to as camping on) a 3G cell for power saving in step S412. If such a 2G cell exists, the processor may perform an inter-RAT cell reselection to reselect to a 2G cell in step S414. 2G cell measurement and inter-RAT cell reselection are well-known in the art, and are briefly described below.

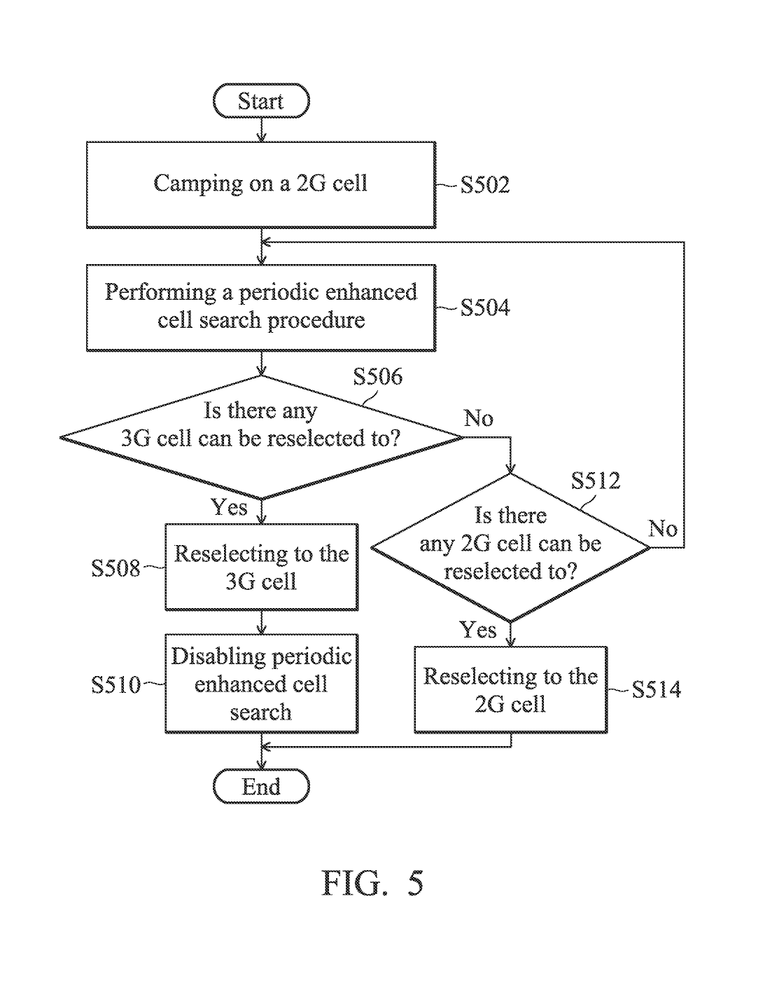

FIG. 5 is a flowchart illustrating an embodiment of a method for preferably staying in 3G cells when the communications apparatus is currently camped on a 2G cell according to an embodiment of the invention. In the embodiment, a 2G cell is camped on as a serving cell in step S502. Regardless of whether the signal quality and/or strength of the 2G cell is good or bad, the processor (for example, the processor 103 or 203) may perform a periodic enhanced cell search procedure in step S504 to find one or more 3G neighboring cells, yielding an earlier opportunity to reselect to a 3G cell. After completing the whole or a portion of the enhanced cell search procedure, the processor may check the search results to determine if there is any 3G cell can be reselected to in step S506. If so, the processor may perform an inter-RAT cell reselection to reselect to the 3G cell in step S508. The 3G candidate cell check may be achieved by inspecting if the S criteria broadcast via the system information by a 3G cell are satisfied. The processor may alternatively determine if the monitored RSCP or Ec/N0 for the 3G candidate cell is higher than a threshold, for example, −105 or −15. The threshold may reflect the communications apparatus's capability, where the RRC Connection may be successfully established when the monitored power level of CPICH of a 3G cell is higher than the threshold. In the embodiment, the periodic enhanced cell search function may be disabled after camping on a 3G cell for power saving in step S510.

If it is determined that there is no 3G cell that can be reselected to in step S506, the processor may try to find a suitable 2G cell which ranks better than the serving cell. If such a 2G cell exists in step S512, the processor may perform an intra-RAT cell reselection to reselect to the 2G cell in step S514. If not, the process may return back to step S504 for performing the periodic enhanced cell search procedure. The intra-RAT cell reselection is well-known in the art, and is briefly described below.

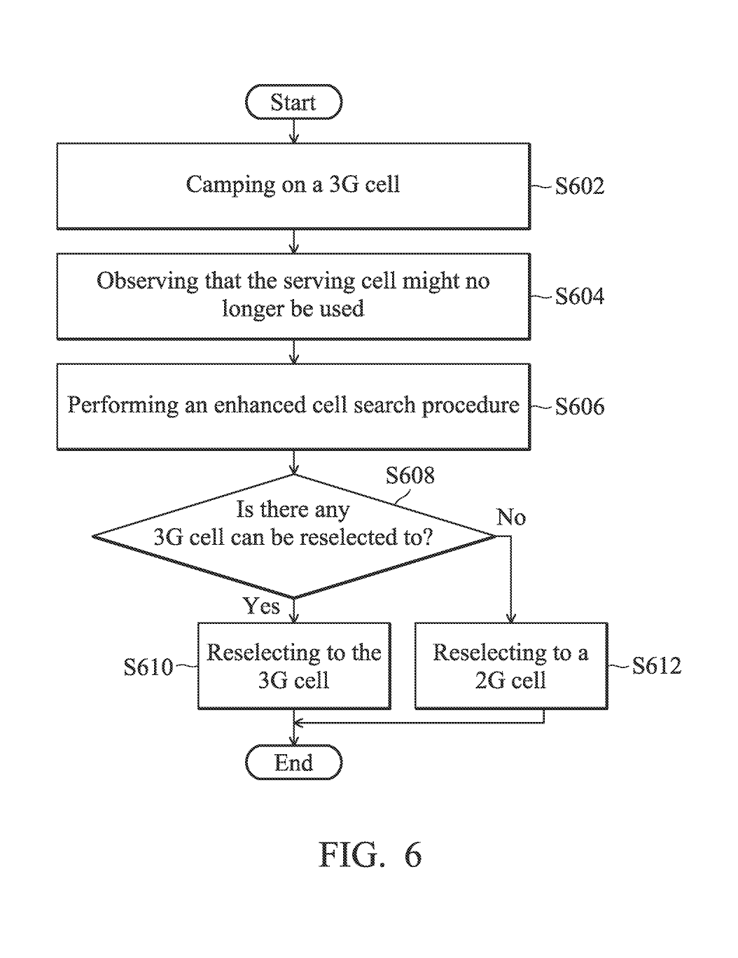

FIG. 6 is a flowchart illustrating an embodiment of a method for preferably staying in 3G cells when the communications apparatus is currently camped on a 3G cell according to another embodiment of the invention. In the embodiment, a 3G cell is camped on as a serving cell in step S602. The communications apparatus may keep monitoring the signal quality and/or signal strength of the serving cell. When observing that the serving cell might no longer be used in Step S604, the processor (for example, the processor 103 or 203) may perform a one-time enhanced cell search procedure in step S606 to find one or more 3G neighboring cells.

After completing the whole or a portion of the enhanced cell search procedure, the processor may check the search results to determine if there is any 3G cell that can be reselected to in step S608. If so, the processor may reselect to the 3G cell in step S610, otherwise, the processor may try to find a suitable 2G cell which ranks better than the serving cell. If such a 2G cell exists, the processor may perform an inter-RAT cell reselection to reselect to a 2G cell in step S612.

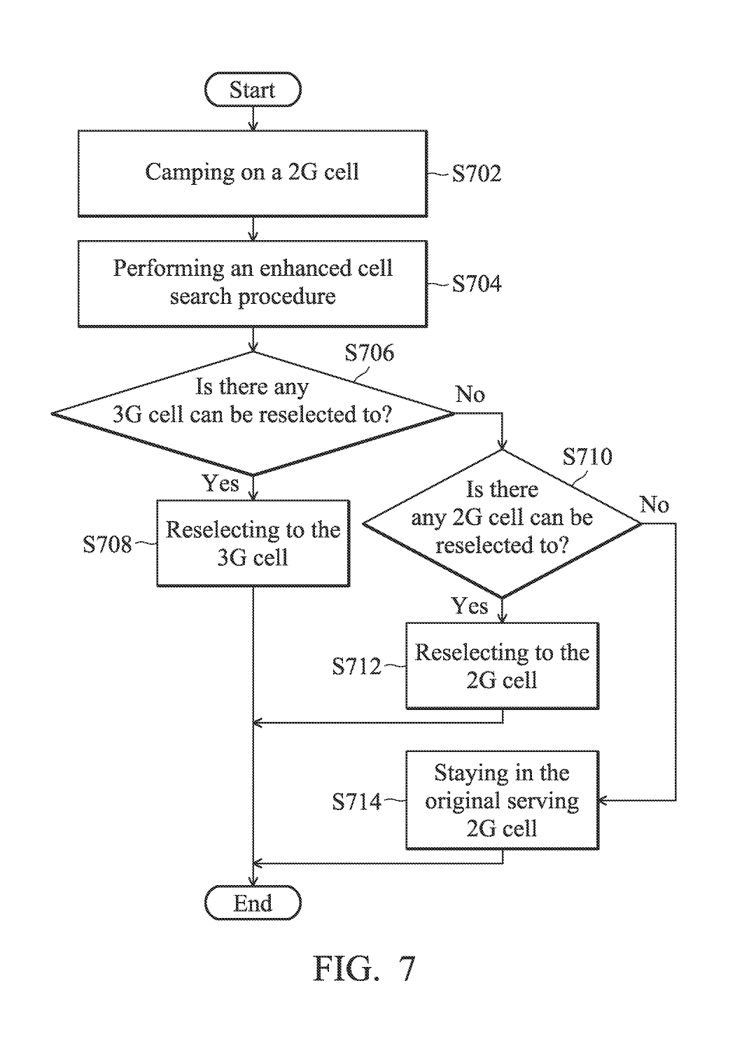

FIG. 7 is a flowchart illustrating an embodiment of a method for preferably staying in 3G cells when the communications apparatus is currently camped on a 2G cell according to another embodiment of the invention. In the embodiment, a 2G cell is camped on as a serving cell in step S702. Regardless of whether the signal quality and/or strength of the 2G cell is good or bad, the processor (for example, the processor 103 or 203) may perform an enhanced cell search procedure in step S704 to find one or more 3G neighboring cells, yielding an earlier opportunity to reselect to a 3G cell. After completing the whole or a portion of the enhanced cell search procedure, the processor may check the search results to determine if there is any 3G cell that can be reselected to in step S706. If so, the processor may perform an inter-RAT cell reselection to reselect to the 3G cell in step S708.

If it is determined that there is no 3G cell can be reselected to in step S706, the processor may try to find a suitable 2G cell which ranks better than the serving cell. If such a 2G cell exists in step S710, the processor may perform an intra-RAT cell reselection to reselect to the 2G cell in step S712. If not, the process may determine to stay in the original serving 2G cell in step S714. Note that, in the embodiments shown in FIG. 6 and FIG. 7, the processor performs a one-time enhanced cell search procedure, rather than a periodic enhanced cell search procedure, to reduce battery power consumption.

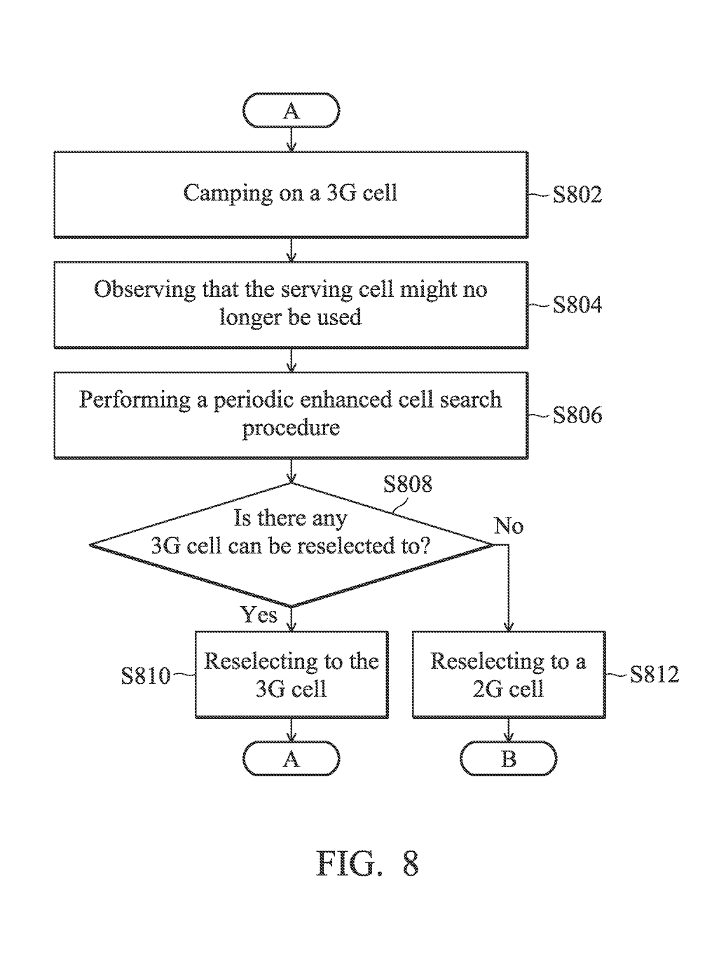

FIG. 8 is a flowchart illustrating an embodiment of a method for preferably staying in 3G cells when the communications apparatus is currently camped on a 3G cell according to yet another embodiment of the invention. In the embodiment, a 3G cell is camped on as a serving cell in step S802. The communications apparatus may keep monitoring the signal quality and/or signal strength of the serving cell. When observing that the serving cell might no longer be used in Step S804, the processor (for example, the processor 103 or 203) may perform a periodic enhanced cell search procedure in step S806 to find one or more 3G neighboring cells.

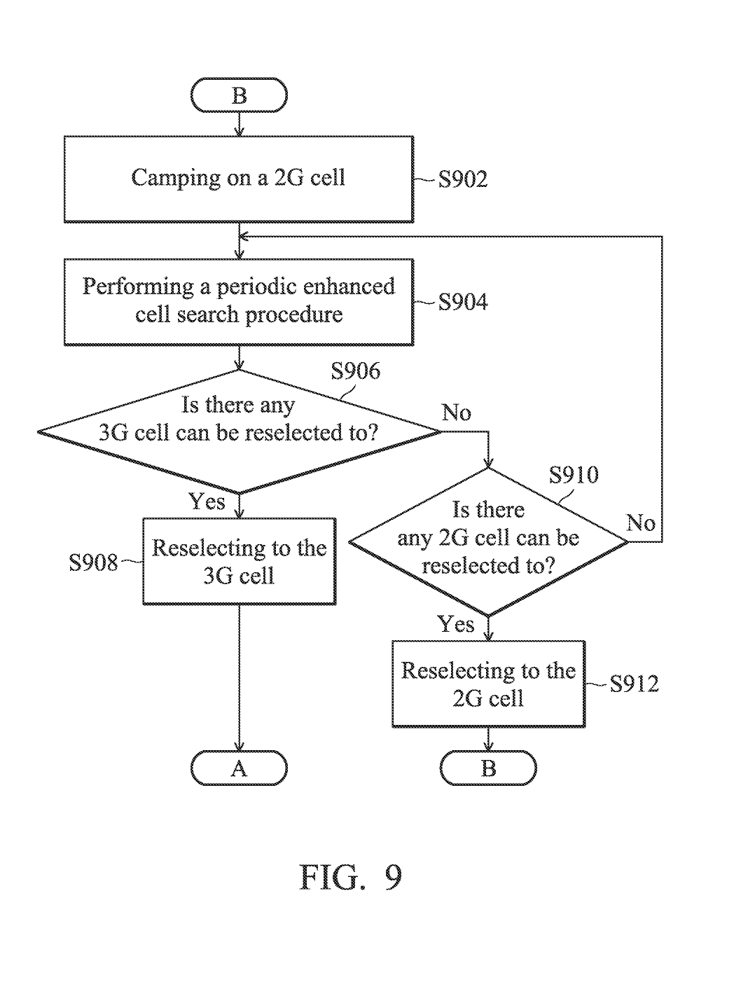

After completing the whole or a portion of the enhanced cell search procedure, the processor may check the search results to determine if there is any 3G cell that can be reselected to in step S808. If so, the processor may reselect to the 3G cell in step S810. The process may then go to the connection point A to camp on the 3G cell as a serving cell and the processor may keep monitoring the signal quality and/or signal strength of the serving cell. If not, the processor may try to find a suitable 2G cell which ranks better than the serving cell. If such a 2G cell exists, the processor may perform an inter-RAT cell reselection to reselect to a 2G cell in step S812. The process may then go to the connection point B as shown in FIG. 9.

FIG. 9 is a flowchart illustrating an embodiment of a method for preferably staying in 3G cells when the communications apparatus is currently camped on a 2G cell according to yet another embodiment of the invention. In the embodiment, a 2G cell is camped on as a serving cell in step S902. Regardless of whether the signal quality and/or strength of the 2G cell is good or bad, the processor (for example, the processor 103 or 203) may perform a periodic enhanced cell search procedure in step S904 to find one or more 3G neighboring cells, yielding an earlier opportunity to reselect to a 3G cell. After completing the whole or a portion of the enhanced cell search procedure, the processor may check the search results to determine if there is any 3G cell that can be reselected to in step S906. If so, the processor may perform an inter-RAT cell reselection to reselect to the 3G cell in step S908. The process may then go to the connection point A to camp on the 3G cell as a serving cell, and the processor may keep monitoring the signal quality and/or signal strength of the serving cell.

If it is determined that there is no 3G cell that can be reselected to in step S906, the processor may try to find a suitable 2G cell which ranks better than the serving cell. If such a 2G cell exists in step S910, the processor may perform an intra-RAT cell reselection to reselect to the 2G cell in step S912. The process may then go to the connection point B to camp on the 2G cell as the serving cell. If not, the process may determine to stay in the original serving 2G cell and the process may then return to step S904 to perform a periodic enhanced cell search procedure to find one or more 3G neighboring cells, yielding an earlier opportunity to reselect to a 3G cell. Note that, in the embodiments shown in FIG. 8 and FIG. 9, the periodic enhanced cell search is enabled after the communications apparatus is powered on, and always on. Thus, there is no operation to disable the periodic enhanced cell search no matter whether the communications apparatus is currently camping on a 2G or 3G cell, resulting in staying in 3G cells as long as possible.

In addition, note that, although the above embodiments describe applications to the 2G/3G dual mode environment, those skilled in the art may apply the inventive methods to the 2G/4G or 2G/3G/4G environments with relevant modifications to ensure that the communications apparatus may camp on and stay in the cells of a RAT with the highest data throughput as long as possible.

While the invention has been described by way of various examples and in terms of preferred embodiment, it is to be understood that the invention is not limited to FIG. 1 to FIG. 9. On the contrary, it is intended to cover various modifications and similar arrangements (as would be apparent to those skilled in the art). Therefore, the scope of the appended claims should be accorded the broadest interpretation so as to encompass all such modifications and similar arrangements.

Use of ordinal terms such as “first” and “second” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus capable of communicating with a first wireless network belonging to a first radio access technology (RAT) and a second wireless network belonging to a second RAT having a higher data transmission throughput than the first RAT and currently camping on a cell belonging to the first RAT or the second RAT, comprising:
a processor, coupled to at least one radio frequency (RF) transceiver for receiving or transmitting RF signals from or to the first wireless network and the second wireless network, and at least one baseband processing device for processing baseband signals received from or transmitted to the first wireless network and the second wireless network,
wherein the processor at least comprises:
a first processor logic unit, performing an enhanced cell search procedure via the RF transceiver to find one or more cell(s) belonging to the second RAT and having stronger signal strength and/or better signal quality than a predetermined threshold, which are not included in a broadcast neighbor cell list; and
a second processor logic unit, determining a suitable cell from among the one or more cell(s) and performing a cell reselection procedure to camp on the suitable cell.

2. The communications apparatus as claimed in claim 1, wherein the first processor logic unit performs the enhanced cell search procedure by performing frequency scan in one or more predetermined frequency band(s), and wherein a registered public land mobile network (RPLMN) provides wireless communications services in one or a combination of one or more predetermined frequency band(s).

3. The communications apparatus as claimed in claim 1, wherein the first processor logic unit performs the enhanced cell search procedure according to an RPLMN frequency list comprising information regarding all frequency band(s) in which an RPLMN provides wireless communications services.

4. The communications apparatus as claimed in claim 1, wherein the first processor logic unit performs the enhanced cell search procedure periodically.

5. The communications apparatus as claimed in claim 1, wherein the first processor logic unit performs the enhanced cell search procedure at least one time.

6. The communications apparatus as claimed in claim 1, wherein the predetermined threshold is one or a combination of signal strength and signal quality of the currently camped-on cell.

7. The communications apparatus as claimed in claim 1, wherein when the currently camped-on cell belongs to the first RAT, a priority of performing the enhanced cell search procedure is higher than a priority of performing a normal cell search procedure to find one or more cell(s) belonging to the first RAT.

8. The communications apparatus as claimed in claim 1, wherein when the currently camped-on cell belongs to the first RAT, the first processor logic unit performs the enhanced cell search procedure regardless of whether the signal strength and/or signal quality of the currently camped-on cell has/have been downgraded.

9. The communications apparatus as claimed in claim 1, wherein when the currently camped-on cell belongs to the first RAT, the first processor logic unit performs the enhanced cell search procedure to find one or more cell(s) having stronger signal strength and/or better signal quality than the predetermined threshold, regardless of whether the signal strength of the cell(s) is stronger than and/or the signal quality of the cell(s) is better than that of the currently camped-on cell.

10. The communications apparatus as claimed in claim 1, wherein when the currently camped-on cell belongs to the second RAT and when a signal strength and/or a signal quality of the currently camped-on cell has/have been downgraded, the first processor logic unit performs the enhanced cell search procedure before reselecting to another suitable cell belonging to the first RAT.

11. The communications apparatus as claimed in claim 1, wherein when the currently camped-on cell belongs to the second RAT, the first processor logic unit performs the enhanced cell search procedure before performing a measurement procedure to measure signal strength and/or signal quality of one or more cell(s) belonging to the first RAT.

12. A method for a communications apparatus to preferably camp on and stay in a cell belonging to a high data transmission throughput radio access technology (RAT), wherein the communications apparatus is capable of communicating with a first wireless network belonging to a first RAT and a second wireless network belonging to a second RAT having a higher data transmission throughput than the first RAT and currently camps on a cell belonging to the first RAT or the second RAT, comprising:
performing an enhanced cell search procedure via a RF transceiver of the communications apparatus by a processor of the communications apparatus to find one or more cell(s) belonging to the second RAT having stronger signal strength and/or better signal quality than a predetermined threshold, which are not included in a broadcast neighbor cell list;
determining a suitable cell from among one or more cell(s) by the processor; and
performing a cell reselection procedure to camp on the suitable cell by the processor.

13. The method as claimed in claim 12, wherein the step of performing the enhanced cell search procedure comprises performing a frequency scan on one or more predetermined frequency band(s), and wherein a registered public land mobile network (RPLMN) of the communications apparatus, with which the communications apparatus is registered, provides wireless communications services in one or a combination of the predetermined frequency band(s).

14. The method as claimed in claim 12, wherein the enhanced cell search procedure is preformed based on an RPLMN frequency list comprising information regarding all frequency band(s) of an RPLMN, and wherein the communications apparatus has registered with the RPLMN and the RPLMN provides wireless communications services in one or a combination of the frequency band(s).

15. The method as claimed in claim 12, wherein the enhanced cell search procedure is preformed periodically.

16. The method as claimed in claim 12, wherein the enhanced cell search procedure is preformed at least one time.

17. The method as claimed in claim 12, wherein the predetermined threshold is one or a combination of the signal strength and signal quality of the currently camped on-cell.

18. The method as claimed in claim 12, wherein when the currently camped-on cell belongs to the first RAT, the enhanced cell search procedure is performed prior to a normal cell search procedure to find one or more cell(s) belonging to the first RAT.

19. The method as claimed in claim 12, wherein when the currently camped-on cell belongs to the first RAT, the enhanced cell search procedure is performed regardless of whether the signal strength and/or signal quality of the currently camped-on cell has/have been downgraded.

20. The method as claimed in claim 12, wherein when the currently camped-on cell belongs to the first RAT, the enhanced cell search procedure is performed to find one or more cell(s) that have stronger signal strength and/or better signal quality than the predetermined threshold, regardless of whether the signal strength of the cell(s) is stronger than and/or the signal quality of the cell(s) is better than that of the currently camped-on cell.

21. The method as claimed in claim 12, wherein when the currently camped-on cell belongs to the second RAT and when the signal strength and/or signal quality of the currently camped-on cell has/have been downgraded, the enhanced cell search procedure is performed before reselecting another suitable cell belonging to the first RAT.

22. The method as claimed in claim 12, wherein when the currently camped-on cell belongs to the second RAT, the enhanced cell search procedure is performed before performing a measurement procedure to measure the signal strength and/or signal quality of one or more cell(s) belonging to the first RAT.
